(19) United States
(12) Patent Application Publication
(10) Pub. No.: US 2005/0062565 A1
(43) Pub. Date: Mar. 24, 2005

(54) Method of using a metal platform for making a highly reliable and reproducible metal contact micro-relay MEMS switch

(76) Inventor: Chia-Shing Chou, Oak Park, CA (US)

Correspondence Address: Chia Chou, 517 Hastings Court, Oak Park, CA, 91377, US

(21) Appl. No.: 10/665,969

(22) Filed: Sep. 18, 2003

(51) Int. Cl. H01H 51/22

(52) U.S. Cl. 335/78

(57) ABSTRACT

A method and apparatus are presented for providing improved reliability, yield, and performance of contacts in micro-electro-mechanical system (MEMS) switches. Specifically, the invention relates to the placement of a metal platform on the base electrodes for making a reliable and reproducible contact. The MEMS switch comprises: an actuating portion attached with a substrate; an actuating portion contact disposed on the actuating portion; and a substrate contact on top of the substrate, the substrate contact including a metal platform portion extending a height therefrom toward the actuating portion contact, wherein the actuating portion contact and the substrate contact are aligned to contact when the actuating portion is moved from a first position to a second position.

### BACKGROUND OF THE INVENTION

(1) Technical Field

The present invention relates to techniques for increasing the reliability, yield, and performance of contacts in micro-electro-mechanical system switches (MEMS). Specifically, the invention relates to the placement of a metal platform on the base electrodes for making a reliable and reproducible contact.

(2) Discussion

Today, there are several types of MEMS switches. One difference among them is in their armature structure. For example, switches from Sandia National Labs and Teravita Technologies use a metal armature. MEMS switches from Rockwell use an armature composed of a metal layer on top of an insulator, and switches from HRL Laboratories, LLC use an insulating armature having a metal electrode that is sandwiched in between two insulating layers. Because of the difference in armature designs, metal contacts in these devices are all fabricated differently;

however, in each of these designs the metal contacts are all integrated with part of the armature. The performance of these switches is mainly determined by the metal contact and the armature design. One important issue, occurring when the metal contact is part of the armature, relates to the fabrication process, wherein performance may be sacrificed if the contact is not well controlled.

U.S. Pat. No. 6,046,659 issued Apr. 4, 2000 to Loo et al. (herein after referred to as the “Loo Patent”) discloses two types of micro-electro-mechanical system (MEMS) switches, an I switch and a T switch. In the “Loo Patent”, both the I and T MEMS switches utilize an armature design, where one end of an armature is affixed to an anchor electrode and the other end of the armature rests above a contact electrode.

A cross-section of the switch shown in FIG. 1A is shown in FIGS. 1B and 1C. FIG. 1A depicts a top view of a T switch 10 as disclosed in the prior art. In FIG. 1B the switch is in an open position, while in FIG. 1C, the switch is in a closed position. In this embodiment, a radio-frequency (RF) input transmission line 18 and a RF-output transmission line 20 are disposed on the substrate 14, shown in FIG. 1B. A conducting transmission line 28 is disposed across one end of an armature 16, allowing for connection between the RF-input transmission line 18 and the RF-output transmission line 20 when the switch is in the closed position. One skilled in the art will appreciate that the cross-section only shows the contact of the armature 16 with the RF-output transmission line 20, since the contact of the armature 16 with the RF-input transmission line 18 is directly behind the RF-output transmission line 20 when looking at the cross-section of the switch. Thus, for ease of explanation, FIGS. 1B and 1C will be discussed emphasizing the RF-output transmission line 20; however, the same explanation also holds for contacting of the RF-input transmission line 18. Further, one skilled in the art will appreciate that the RF-input and RF-output transmission lines are labeled as such for convenience purposes only and are interchangeable.

When the switch is in an open position, the transmission line 28 sits above (with a small gap) the RF-input transmission line 18 and the RF-output transmission line 20. Thus, the transmission line 28 is electrically isolated from both the RF-input transmission line 18 and the RF-output transmission line 20. Furthermore, because the RF-input transmission line 18 is not connected with the RF-output transmission line 20, the RF signals are blocked and they cannot conduct from the RF-input transmission line 18 to the RF-output transmission line 20.

When the switch is in closed position, the transmission line 28 is in electrical contact with both the RF-output transmission line 20, and the RF-input transmission line 18. Consequently, the three transmission lines 20, 28, and 18 are connected in series to form a single transmission line in order to conduct RF signals. The “Loo Patent” also provides switches that have conducting dimples 24 attached with the transmission line 28 which defme metal contact areas to improve contact characteristics.

FIG. 1B is a general overview of a prior art micro-electro-mechanical system (MEMS) switch 10 of FIG. 1A in an open position. A conducting dimple 24 protrudes from the armature 16 toward the RF-output transmission line 20. The transmission line 28 (shown in FIG. 1A) is deposited on the armature 16 and electrically connects the dimple 24 associated with the RF-output transmission line 20 to another dimple 24′ associated with the RF-input transmission line 18.

FIG. 1C depicts the MEMS switch 10 of FIG. 1A in a closed state. When a voltage is applied between the suspended armature bias electrode 30 and the substrate bias electrode 22, an electrostatic attractive force will pull the suspended armature bias electrode 30 as well as the attached armature 16 towards the substrate bias electrode 22, and the contact dimple 24 will touch the RF-output transmission line 20. The contact dimple 24 associated with the RF-input transmission line 18 will also come into contact with the RF-input transmission line 18, thus through the transmission line 28 (shown in FIG. 1A) the RF-input transmission line 18 is electrically connected with the RF-output transmission line 20 when the switch is in a closed position.

FIG. 2A depicts a top view of an I switch 200 as disclosed in the prior art. FIG. 2B depicts a direct current (DC) cross-section of the switch 200 while, FIG. 2C depicts a RF cross-section of the switch 200. In FIG. 2B, a DC signal is passed from the DC contact 220 through an anchor point 222 and into a DC cantilever structure 224. A substrate bias electrode 226 is positioned on the substrate 14. Also shown in FIG. 2B is a metal dimple 216 which will be described later in connection with FIG. 2C. As a DC bias is applied to the DC contact 220 and the substrate bias electrode 226, the DC cantilever structure 224 is pulled toward the substrate 14, causing the RF cantilever structure 215, shown in FIG. 2A, to also be deflected toward the substrate 14. FIGS. 2D and 2E depict the switch 200 in the closed position.

FIG. 2C depicts the RF cross-section of switch 200. The RF-input transmission line 210 passes through anchor point 214 and into the RF cantilever structure 215. The metal dimple 216 protrudes from the RF cantilever structure 215. For ease of explanation the RF cantilever structure 215 and the DC cantilever structure 224 are described herein as two separate structures; however, one skilled in the art will appreciate that these two structures are typically made of one piece of material. The metal dimple 216 provides an electrical contact between a RF-input transmission line 210 and a RF-output transmission line 212. As discussed above, when a DC bias is applied to the DC contact 220 and the substrate bias electrode 226, the RF cantilever structure 215 is deflected toward the substrate 14. The deflection of the RF cantilever structure 215 toward the substrate 14 provides an electrical path between the RF-input transmission line 210 and the RF-output transmission line 212. FIGS. 2D and 2E depict the switch 200 in the closed position.

The process of forming the dimple on the armature requires very controlled etching times. The dimple is typically formed by first depositing an armature on top of a sacrificial layer. Then a hole is etched through the armature into the sacrificial layer immediately above the RF-input and/or output transmission line. The dimple is then deposited to fill the etched hole. In this case, the height of the dimple depends on the depth of the etching through the hole into the sacrificial layer. This etching process is monitored by time. The time required to obtain the proper etch depth is mainly determined from trial and error etching experiments. Because the etching is a time-controlled process, the etch depth may vary from run to run and from batch to batch depending upon the etching equipment parameters. Thus, the quality of the contact will vary from run to run. For example, if the dimple is made too shallow, the contact will be less optimal. If the dimple is made too deep, a joint between the dimple and the input transmission line may form, ruining the switch. Therefore, what are required are a switch and a method of producing a switch that may be manufactured consistently.

### SUMMARY

The present invention presents a MEMS switch and a method for manufacturing.

In one embodiment, the present invention relates to a micro-electro-mechanical system (MEMS) switch comprising: an actuating portion attached with a substrate; an actuating portion contact disposed on the actuating portion, the actuating portion contact being located between the actuating portion and the substrate; and a substrate contact on top of the substrate, the substrate contact including a metal platform portion extending a height therefrom toward the actuating portion contact, wherein the actuating portion contact and the substrate contact are aligned to contact when the actuating portion is moved from a first position to a second position, wherein an area of the metal platform portion is independently selectable of an area of the actuating portion contact.

In another embodiment, the metal platform portion is comprised of at least one metal selected from a group consisting of: gold, platinum, silver, copper, aluminum, and molybdenum.

In a further embodiment, the substrate is comprised of at least one material selected from a group consisting of: gallium arsenide, indium phosphide, high resistivity silicon, glass, ceramic, and silicon germanium.

In a further embodiment, the actuating portion is a cantilever structure, the cantilever structure having a first region and a second region, the first region of the cantilever structure being attached with the substrate.

In a further embodiment, the switch further comprises a first RF transmission line and a second RF transmission line formed on the substrate, wherein the actuating portion contact is formed as a contact transmission line having a first contact region and a second contact region, with the first contact region aligned with the at least a portion of the first RF transmission line, and the second contact region aligned with at least a portion of the second RF transmission line, whereby when the cantilever is moved from the first position to the second position, the contact transmission line forms an electrical path between the first and second RF transmission lines.

In a further embodiment, the switch further comprises a substrate bias electrode disposed on the substrate; and a cantilever bias electrode included with the cantilever, the substrate bias electrode and the cantilever bias electrode forming a bias electrode pair such that the bias electrode pair may be actuated to urge the cantilever bias electrode toward substrate bias electrode, moving the cantilever structure from the first position to the second position.

In a further embodiment, the switch further comprises a first RF transmission line and a second RF transmission line formed on the substrate, wherein the actuating portion contact is formed as a contact transmission line having a first contact region and a second contact region, with the first contact region attached with at least a portion of the first RF transmission line, and the second contact region aligned with at least a portion of the second RF transmission line, whereby when the cantilever is moved from the first position to the second position, the contact transmission line forms an electrical path between the first and second RF transmission lines.

In a further embodiment, the cantilever structure has into two sections: a DC cantilever section and a RF cantilever section, the DC cantilever section being attached with the substrate at a first portion and the RF cantilever section being attached with the substrate at a first portion, the switch further comprising: a first RF transmission line disposed on the substrate, the first RF transmission line including the substrate contact; and a second RF transmission line, the second RF transmission line being included with the RF cantilever section, the second RF transmission line including the actuating portion contact, whereby when the cantilever is moved from the first position to the second position, the actuating portion contact contacts the substrate contact creating an electrical path between the first and second RF transmission lines.

In a further embodiment, the switch further comprises a substrate bias electrode disposed on the substrate; and a DC cantilever bias electrode included with the DC cantilever section, the substrate bias electrode and the DC cantilever bias electrode forming a bias electrode pair such that the bias electrode pair may be actuated to urge the DC cantilever bias electrode toward the substrate bias electrode, moving the cantilever structure from the first position to the second position.

In a further embodiment, the second region of the cantilever structure is attached with the substrate.

In a further embodiment, the switch further comprises: a first RF transmission line included with the cantilever structure, wherein the first RF transmission line includes the actuating portion contact; a second RF transmission line disposed on the substrate, the second RF transmission line including the substrate contact, whereby when the cantilever is moved from the first position to the second position, the actuating portion contact contacts the substrate contact.

In a further embodiment, the switch further comprises: a substrate bias electrode disposed on the substrate; and a cantilever bias electrode included with the cantilever structure, the substrate bias electrode and the cantilever bias electrode forming a bias electrode pair such that the bias electrode pair may be actuated to urge the cantilever bias electrode toward the substrate bias electrode, moving the cantilever structure from the first position to the second position.

### BRIEF DESCRIPTION OF THE DRAWINGS

The objects, features and advantages of the present invention will be apparent from the following detailed descriptions of the preferred aspect of the invention in conjunction with reference to the following drawings, where:

FIG. 1A is a top view of a prior art T MEMS switch;

FIG. 1B is a side-view of the prior art T MEMS switch presented in FIG. 1A, in an open position;

FIG. 1C is a side-view of the prior art T MEMS switch presented in FIG. 1A, in a closed position;

FIG. 2A is a top view of a prior art I MEMS switch;

FIG. 2B is a side-view of the DC cross-section of the prior art I MEMS switch presented in FIG. 2A, in an open position;

FIG. 2C is a side-view of the RF cross-section of the prior art I MEMS switch presented in FIG. 2A, in an open position;

FIG. 2D is a side-view of the DC cross-section of the prior art I MEMS switch presented in FIG. 2A, in a closed position;

FIG. 2E is a side-view of the RF cross-section of the prior art I MEMS switch presented in FIG. 2A, in a closed position;

FIG. 3A is a general overview of a T MEMS switch in accordance with the present invention;

FIG. 3B is a side-view of the T MEMS switch presented in FIG. 3A, in an open position;

FIG. 3C is a cross-section of the T MEMS presented in FIG. 3A, in the open position;

FIG. 3D is an exploded view of the metal platform of the T MEMS switch, presented in FIG. 3A;

FIG. 3E is a side-view of the T MEMS presented in FIG. 3A, in a closed position;

FIG. 3F is a cross-section of the T MEMS switch presented in FIG. 3A, in the closed position;

FIG. 4A is a DC cross-section of an I MEMS switch in an open position in accordance with the present invention;

FIG. 4B is a RF cross-section of the I MEMS switch presented in FIG. 4A, in an open position;

FIG. 4C is the DC cross-section of the I MEMS switch presented in FIG. 4A, in a closed position;

FIG. 4D is the RF cross-section of the I MEMS switch presented in FIG. 4A, in a closed position;

FIG. 5A depicts a cross-section of a doubly supported cantilever beam MEMS switch in an open position in accordance with the present invention;

FIG. 5B depicts a cross-section of a doubly supported cantilever beam MEMS switch presented in FIG. 5A, in a closed position; and

FIGS. 6-17 depict various exemplary process steps for forming a switch in accordance with the present invention.

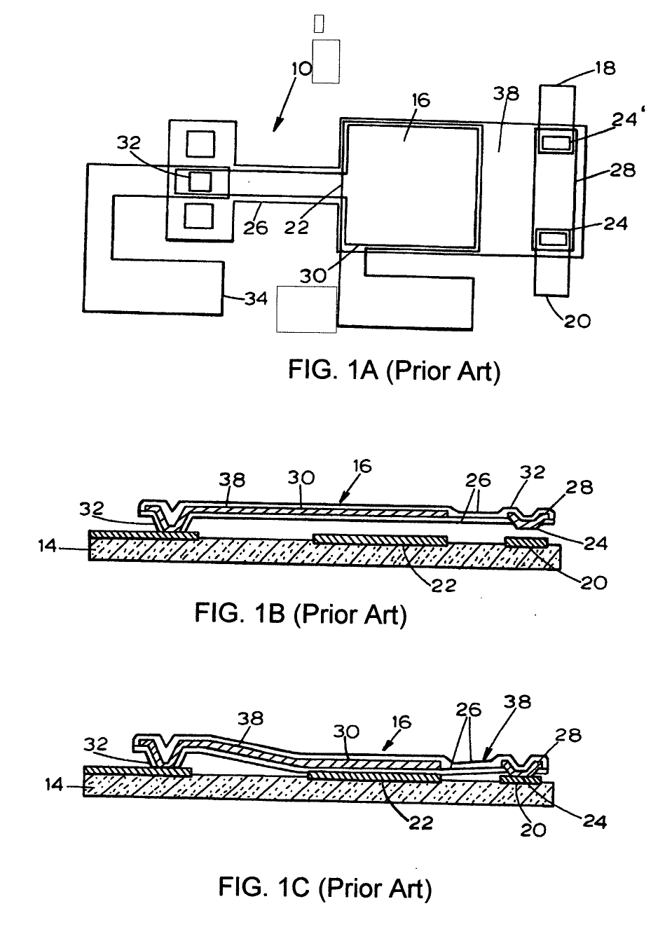

### DETAILED DESCRIPTION

The present invention relates to techniques for increasing the reliability and performance of contacts in micro-electro-mechanical system (MEMS) switches. Specifically, the invention relates to the placement of a metal platform on the base electrode. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein, may be applied to a wide range of aspects. Thus, the present invention is not intended to be limited to the aspects presented, but is to be accorded the widest scope consistent with the principles and novel features disclosed herein. Furthermore, it should be noted that unless explicitly stated otherwise, the figures included herein are illustrated diagrammatically and without any specific scale, as they are provided as qualitative illustrations of the concept of the present invention.

In order to provide a working frame of reference, first a glossary of terms used in the description and claims is given as a central resource for the reader. Next, a discussion of various physical aspects of the present invention is provided. Finally, a discussion is provided to give an understanding of the specific details.

(1) Glossary

Before describing the specific details of the present invention, a centralized location is provided in which various terms used herein and in the claims are defined. The glossary provided is intended to provide the reader with a general understanding for the intended meaning of the terms, but is not intended to convey the entire scope of each term. Rather, the glossary is intended to supplement the rest of the specification in more accurately explaining the terms used.

Actuation portion: a part of a switch that moves to connect or disconnect an electrical path. Some examples include an armature and a cantilever.

Metal platform portion: an area of metal that protrudes from a substrate providing increased contact reliability in MEMS switches. Also referred to as a metal base contact.

(2) Principal Aspects

The present invention has two principal aspects. The first is a MEMS switch. The MEMS switch includes an actuating portion which moves from a first position to a second position, wherein in the second position the switch provides a path for a RF signal. A metal platform is placed on a portion of an RF-line that is in contact with a substrate upon which the MEMS switch is fabricated. The second physical aspect is a method of manufacturing the MEMS switch.

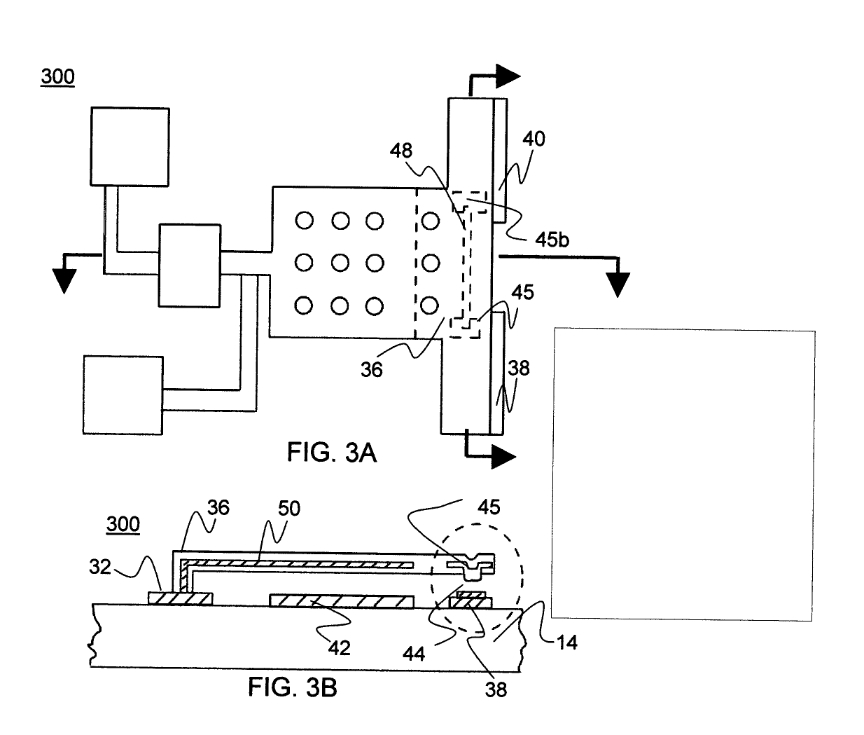

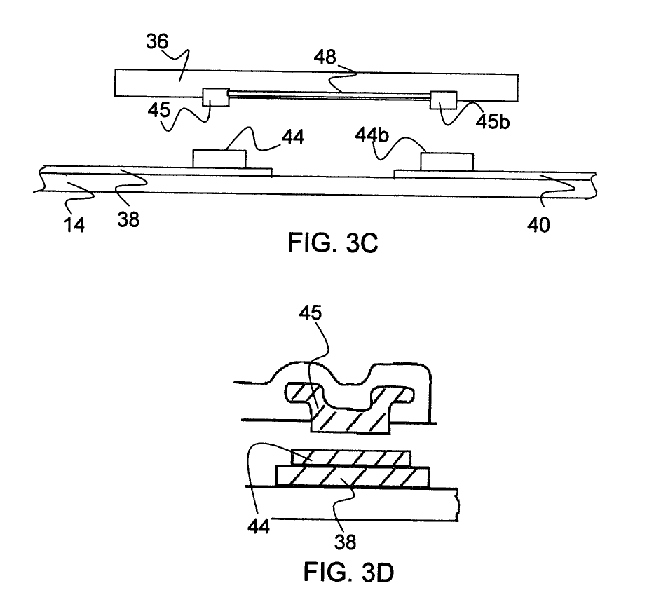

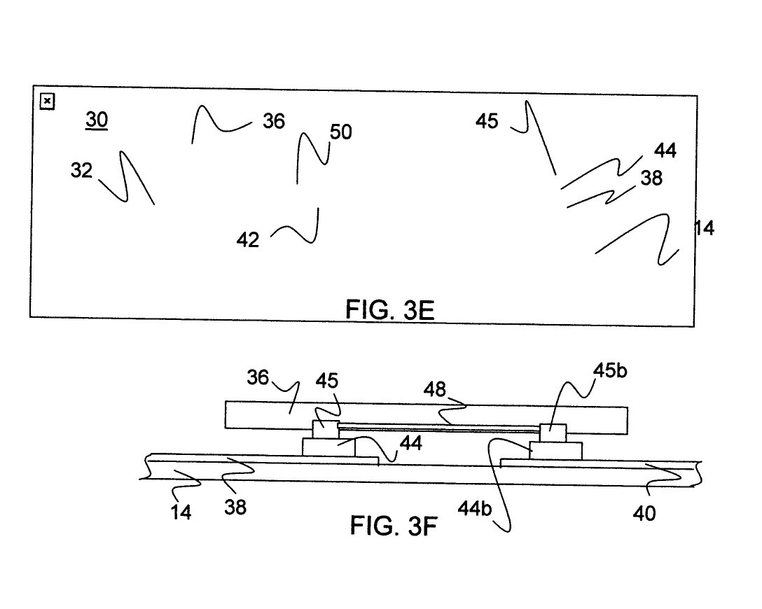

FIG. 3A is a general overview of a T MEMS switch 300. An armature 36 allows for an electrical connection between a first RF transmission line, i.e. a RF-input transmission line 40 and a second RF transmission line, i.e. RF-output transmission line 38, when the switch is in a closed position.

FIG. 3B shows one cross-section of the T MEMS switch 300. One skilled in the art will appreciate that the cross-section only shows the contact of the armature 36 with the RF-output transmission line 38, since the contact of the RF-input transmission line 40 is directly behind the RF-output transmission line 38 when looking at the cross-section of the switch. One end of the armature 36 is affixed to an anchor electrode 32 on a substrate 14. The other end of the armature 36 is positioned over the RF-line which is divided into two separate sections, the RF-input transmission line 40 and the RF-output transmission line 38. The RF-input transmission line 40 and RF-output transmission line 38 are separated by a gap. A substrate bias electrode 42 is attached with the substrate 14 below the armature 36. The armature 36 sits above the substrate bias electrode 42 and is electrically isolated from the substrate bias electrode 42 by an air gap forming a parallel plate capacitor when the MEMS switch 300 is in an “open” position. An output conducting metal platform 44 is placed on the RF-output transmission line 38. An output top dimple electrode 45 is placed on one end of the armature 36 above the output conducting metal platform 44. Similarly, an input conducting metal platform 44b is placed on the RF-input transmission line 40, and an input top dimple electrode 45b is placed on the end of the armature 36 above the input conducting metal platform 44b, shown in FIG. 3C. The output top dimple electrode 45 and the input top dimple electrode 45b are electrically connected via a transmission line 48, shown in FIG. 3A. In one embodiment, the transmission line 48 is a metal film transmission line embedded inside the armature 36. FIG. 3D depicts an exploded view of the input top dimple electrode and the conducting metal platform 44 for the base contact.

FIG. 3E depicts the cross-section of the T MEMS switch 300 in FIG. 3B in a closed state. When a voltage is applied between a suspended armature bias electrode 50 and the substrate bias electrode 42, an electrostatic attractive force will pull the suspended armature bias electrode 50 as well as the attached armature 36 towards the substrate bias electrode 42. Consequently, the output top dimple electrode 45 touches the output conducting metal platform 44 and the input top electrode 45b touches the input conducting metal platform 44b (shown in FIG. 3F) providing a good electrical contact. Thus, the output conducting metal platform 44, the output top dimple electrode 45, the transmission line 48, the input top dimple electrode 45b, and the input conducting metal platform 44b provide an electrical path for bridging the gap between the RF-input transmission line 40 and the RF-output transmission line 38, thereby closing the MEMS switch 300.

The substrate 14 may be comprised of a variety of materials. If the MEMS switch 300 is intended to be integrated with other semiconductor devices (i.e. low-noise high electron mobility transistor (HEMT) monolithic microwave integrated circuit (MMIC) components), it is preferable to use a semi-insulating semiconducting substance such as gallium arsenide (GaAs), indium phosphide (InP) or silicon germanium (SiGe) for the substrate 14. This allows the circuit elements as well as the MEMS switch 300 to be fabricated on the same substrate using standard integrated circuit fabrication technology such as metal and dielectric deposition, and etching by using the photolithographic masking process. Other possible substrate materials include silicon, various ceramics, and quartz. The flexibility in the fabrication of the MEMS switch 300 allows the switch 300 to be used in a variety of circuits. This reduces the cost and complexity of circuits designed using the present MEMS switch.

In the T MEMS switch (see FIGS. 3A-3F), the area of each of the conducting metal platforms 44 and 44b may be formed with a top area greater than an area of the respective top electrode 45 and 45b. Conversely, the area of each of the bottom conducting metal platforms 44 and 44b may be formed with a top area less than an area of the respective top electrode 45 and 45b. Generally, the area of the metal platforms 44 and 44b is independently selectable from the area of the respective top electrode 45 and 45b.

When actuated by electrostatic attraction, the armature 36 bends towards the substrate 14. This results in the output top dimple electrode 45 and the input top dimple electrode 45b on the armature 36 contacting the output metal platform 44 and input metal platform 44b respectively, and the armature 36 bending to allow the suspended armature bias electrode 50 to physically contact the substrate bias electrode 42. This fully closed state is shown in FIG. 3E. The force of the metallic contact between the output metal platform 44 and the output top dimple electrode 45 (also the input metal platform 44b and the input top dimple electrode 45b) is thus dependent on the spring constant force at the output and input metal platforms 44, 44b when the switch is closed. Metallic switches that do not have protruded dimple contact designs, have contacts that depend upon the whole armature flexibility and bias strength. It is considered that this type of metal contact switch is less reliable than the micro-relay switches with protruded dimple contacts such as those disclosed in this writing. In addition to improving the switch reliability, the quality of the contact itself is improved by the dimple because the dimple has a controllable geometry such as size (area and height) and shape. Thus, MEMS switches without the dimple 44, 44b are more likely to have time-varying contact characteristics, a feature that may make them difficult or impossible to use in some circuit implementations.

One skilled in the art will appreciate that the RF-input transmission line 40 may be permanently attached with one end of the transmission line 48 in the armature 36. In this case, the switch is open when a gap exists between the RF-output transmission line 38 and the transmission line 48. Further, one skilled in the art will appreciate that the RF-output transmission line 38 may be permanently attached with one end of the transmission line 48 in the armature 36. In this case the switch is open when a gap exists between the RF-input transmission line 40 and the transmission line 48.

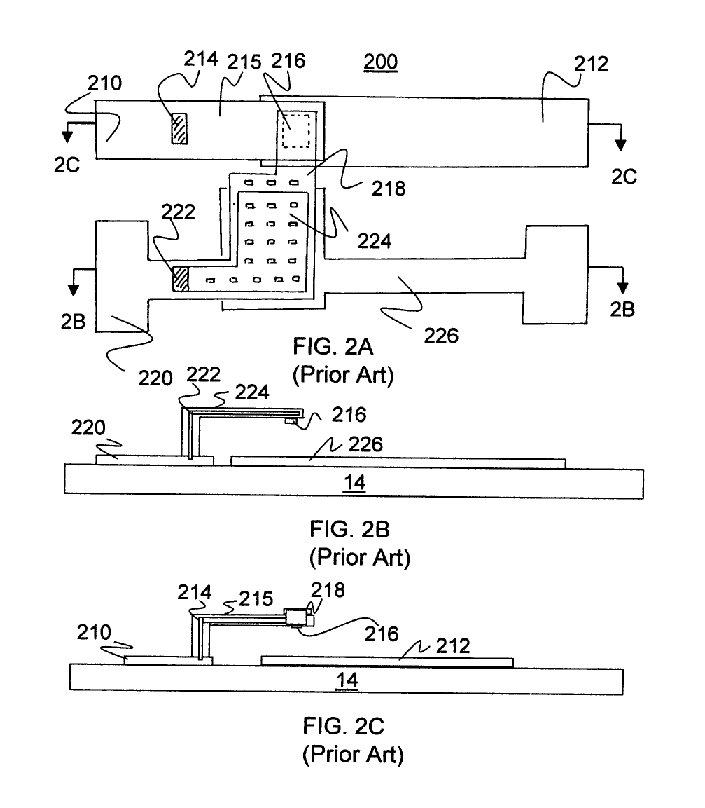

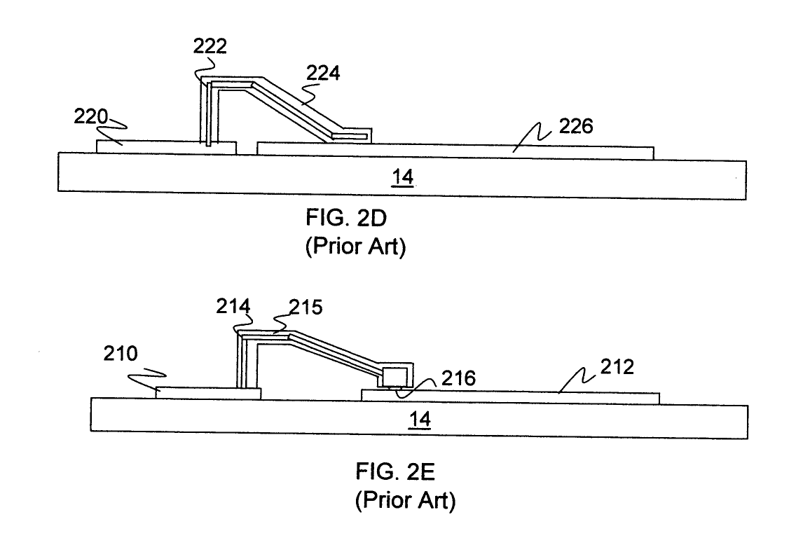

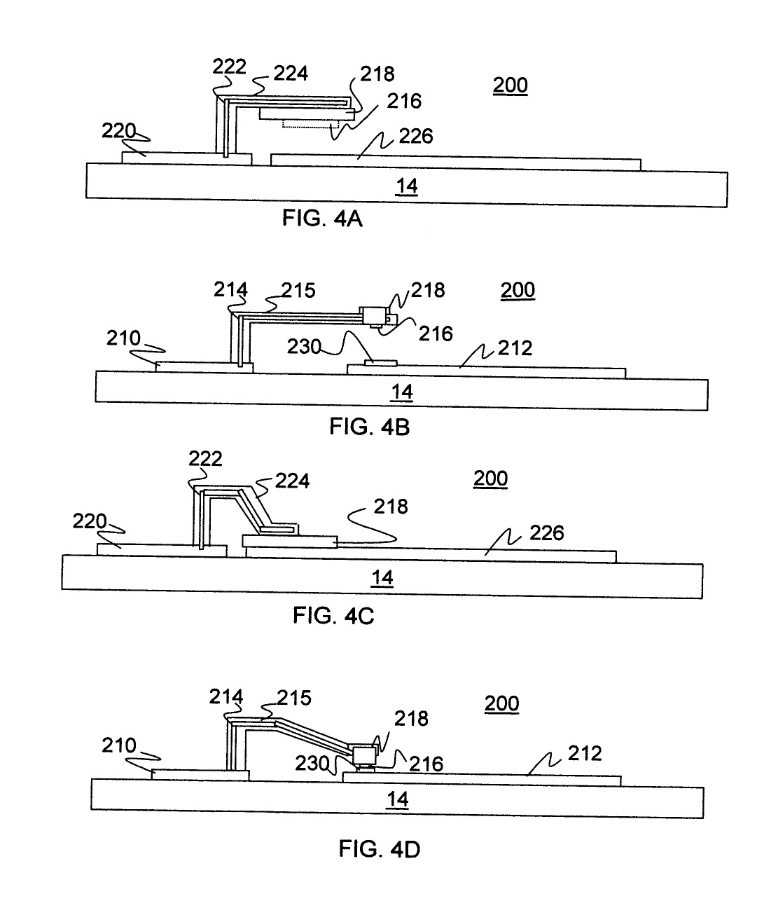

FIG. 4A depicts a DC cross-section of an I MEMS switch in accordance with the present invention. The top view of the I MEMS switch is unchanged from the prior art FIG. 2A. One difference between the prior art and the present invention is a metal platform 230 on a RF electrode protruded from the substrate (shown in FIG. 4B).

Depicted in FIG. 4A, a DC signal is passed from the DC contact 220 through an anchor point 222 and into the DC cantilever structure 224. In the cross-sectional view of FIG. 4A, a portion of a metal dimple 216 (shown more clearly in FIG. 4B) can be seen in the background. A substrate bias electrode 226 is positioned on the substrate 14. As a DC bias is applied to the DC contact 220 and the substrate bias electrode 226, the DC cantilever structure 224 is pulled toward the substrate 14. FIGS. 4C and 4D depict the switch of FIGS. 4A and 4B in the closed position.

FIG. 4B depicts the RF cross-section of switch 200. The RF-input transmission line 210 passes through anchor point 214 and into the RF cantilever structure 215. The metal dimple 216 passes through the RF cantilever structure 215. The metal dimple 216 also provides an electrical contact between the RF-input transmission line 210 and the RF-output transmission line 212 when the switch is in a closed position. In addition, a metal platform 230 is positioned on the substrate 14, attached with the RF-output transmission line 212. The metal platform 230 and the metal dimple 216 are aligned such that the metal platform 230 and the metal dimple 216 contact each other when the switch is in the closed position. As discussed above, when a DC bias is applied to the DC contact 220 and the substrate bias electrode 226, the DC cantilever structure 224 is pulled toward the substrate 14. The deflection of the DC cantilever structure 224 toward the substrate 14 also causes the RF cantilever structure 215 to bend toward the substrate 14, providing an electrical path between the RF-input transmission line 210 and the RF-output transmission line 212 through the metal platform 230. FIGS. 4C and 4D depict the switch in the closed position.

In the I MEMS switch (see FIGS. 4A-4D), the gap between the metal platform 230 and the metal dimple 216 is smaller than the gap between the substrate bias electrode 226 and the suspended armature bias electrode in the armature 224. When actuated by electrostatic attraction, the armature, comprising of the DC cantilever structure 224 and the RF cantilever structure 215, bends towards the substrate 14. First, the metal dimple 216 on the RF cantilever structure 215 contacts the metal platform 230, at which point the armature bends to allow the DC cantilever structure 224 to physically contact the substrate bias electrode 226. This fully closed state is shown in FIGS. 4C and 4D. The force of the metallic contact between the metal platform 230 and the metal dimple 216 is thus dependent on the spring constant force at the metal platform 230 when the switch is closed. Metallic switches that do not have contact dimples, have contacts that depend upon the whole armature flexibility and bias strength. It is considered that this type of metal contact switch is less reliable than the micro-relay switches with dimple contacts such as those disclosed in this writing. In addition to improving the switch reliability, the quality of the contact itself is improved by the dimple because the dimple has a controllable geometry such as size (area and height) and shape. Thus, MEMS switches without the metal platform 230 are more likely to have time-varying contact characteristics, a feature that may make them difficult or impossible to use in some circuit implementations.

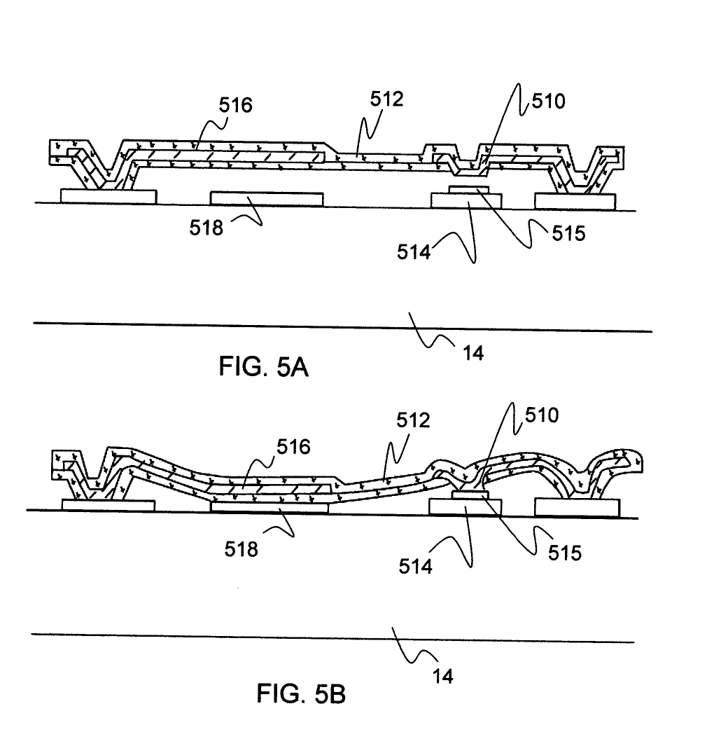

FIG. 5A depicts a cross-section of a doubly supported cantilever beam MEMS switch. A RF-input transmission line 510 is included in a cantilever beam 512. A RF-output transmission line 514 is located on a substrate 14. A metal platform 515 is attached with the RF-output transmission line 514 to improve the contact of the MEMS switch. The cantilever beam 512, unlike the switches previously discussed, is attached with the substrate 14 at two ends. The cantilever beam 512 also includes a cantilever bias electrode 516. A substrate bias electrode 518 is located on the substrate 14. When a DC bias is applied to the cantilever bias electrode 516 and the substrate bias electrode 518, the cantilever beam 512 moves from the open position, shown in FIG. 5A to a closed position, shown in FIG. SB. In the closed position, an electrical path is created between the RF-input transmission line 510 and the RF-output transmission line 514.

As discussed above, the prior art MEMS switches have dimples attached with the armature. Because the formation of the dimple in the armature requires a time-controlled etching process, the yield and performance of the MEMS switches will vary from lot to lot. However, with the design disclosed herein by placing a metal platforms on the input and output RF electrodes and are protruded from the substrate 14 rather than having a deep dimple on the armature, the yield and performance of MEMS switch fabrication is increased. Potential applications of these MEMS switches are in the RF, microwave and millimeter wave circuits, and wireless communications spaces. For example, these MEMS switches can be used in commercial satellites, antenna phase shifters for beam-steering, and multi-band and diversity antennas for wireless cell phones and wireless local area networks (WLANS).

The formation of the metal platform on the substrate is generally accomplished by a well-controlled thin film deposition process. The advantage is that a larger and taller dimple on the substrate will establish and define the dimple contact structure instead of being controlled by the etching process through the armature. Preferably, a shallow dimple, referred to above as the top electrode, is placed on the armature. This shallow dimple is not subject to the same critical etching as its larger predecessor in the prior art. Because of the metal platform on the substrate, this fabrication process provides flexibility and control in making the gap between the upper and lower metal contacts. As previously discussed, this gap is an important means for controlling the isolation parameter of the MEMS switch.

The following is an exemplary set of steps that may be used in the manufacturing of the device disclosed herein. One skilled in the art will appreciate that the steps outlined are to indicate changes from the prior art manufacturing process, and are not intended to be a complete list of all steps used in the process. One skilled in the art will appreciate that the MEMS switches may have varying designs, such as I configurations and T configurations. However, the manufacturing steps disclosed herein are for the formation of a metal platform on a substrate, which may be utilized in any MEMS switch configuration. The manufacturing process is described using the terminology for the T configuration as an illustration.

FIG. 6 depicts a substrate 14. A first metal layer 503 is typically deposited on the substrate 14. This metal layer 503 is used to form an input contact electrode 33, an anchor electrode 32, RF-input and output lines and a substrate bias electrode 42 on the substrate 14. In one embodiment, the metal layer 503 is between one micron and three microns thick gold (Au) and the substrate 14 is a material such as Gallium Arsenide (GaAs), high resistivity silicon (Si) or glass/Quartz.

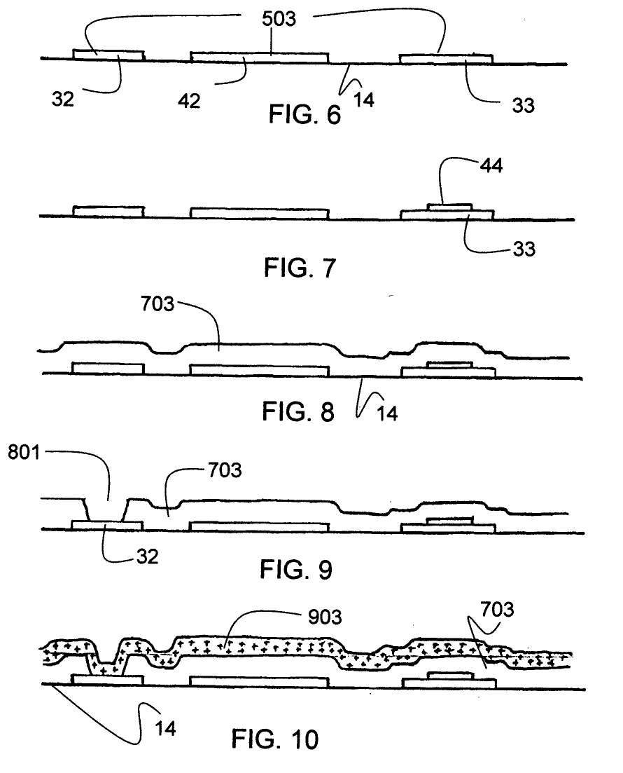

Next, as shown in FIG. 7, a second metal layer 44 is deposited on the input contact electrodes 33. In one embodiment, the second metal layer 44 is 0.5 microns thick gold (Au) layer and forms an input metal platform for the base contact 44.

Then, as shown in FIG. 8, a sacrificial oxide layer 703 is deposited over the substrate 14. This sacrificial oxide layer 703 used to provide the base for the armature, and will later be removed. In one embodiment, the sacrificial oxide layer 703 is between a two microns or three microns thick silicon dioxide layer.

Following, as shown in FIG. 9, a via 801 is etched in the sacrificial oxide layer 703 over the anchor electrode 32.

Then, as shown in FIG. 10, a low stress Nitride layer 903 may be deposited by Plasma Enhanced Chemical Vapor Deposition (PECVD) over the sacrificial oxide layer 703. In one embodiment, the low stress Nitride layer 903 is between one micron and two microns thick.

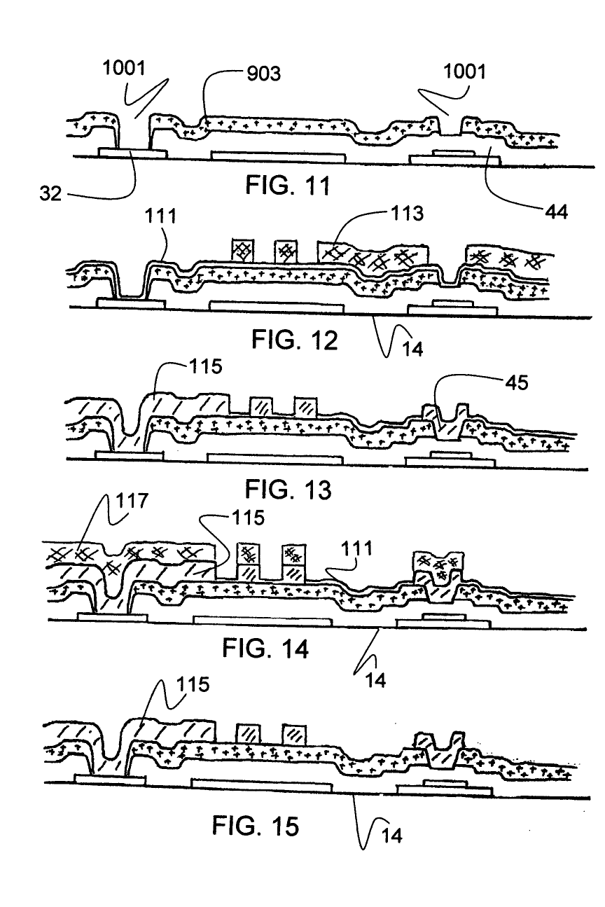

The next step is shown in FIG. 11, where via holes 1001 are created wherein the nitride layer 903 is removed over the anchor electrode 32 and in a small area over the input metal platform 44. The removal of the nitride layer 903 over the small area over the input metal platform 44 provides for a small input dimple or an input top electrode 45 (shown in FIG. 3B) attached with the armature 36. This step of removal may be accomplished using dry etching.

Next, as shown in FIG. 12, a third metal layer 111 is deposited over the substrate 14. The third metal layer 111 may be gold (Au). In one embodiment, the third metal layer 111 is between one and two microns thick. After the deposition of the third metal layer 111, a photoresist layer 113 is placed over areas of the third metal layer 111 that are unwanted. The third metal layer 111 is then plated using techniques well known in the art, resulting in a plated layer 115 shown in FIG. 13. The third metal layer allows for the formation of the input top electrode 45, the transmission line, and the armature bias electrode.

Then, as shown in FIG. 14, a gold etch photoresist layer 117 is disposed over the areas of the plated layer 115 to be protected. Next, the un-protected third metal layer 111 etched so that the un-protected third metal layer 111 is removed from the areas where the photoresist layer 117 was placed. The photoresist layer 117 is then removed. The etching may be wet etching. The result is shown in FIG. 15.

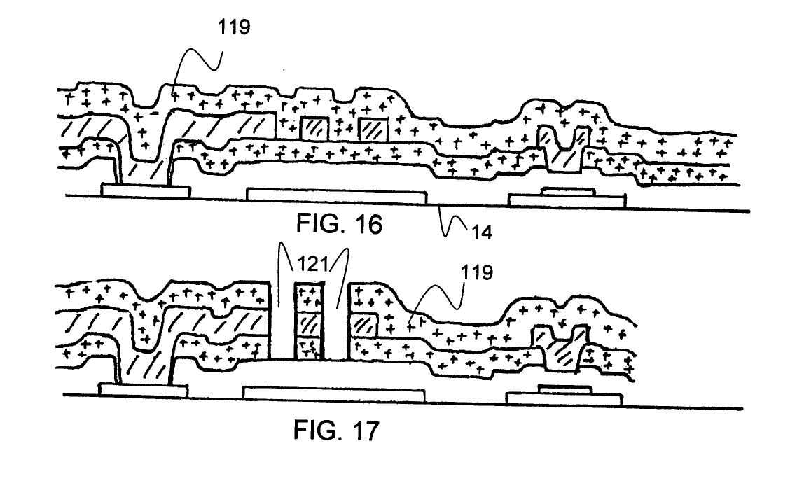

Next, as depicted in FIG. 16, a low stress structure Nitride layer 119 may be deposited using PECVD to cover the substrate 14. In one embodiment, the low stress Nitride layer 119 is one to two microns thick.

As depicted in FIG. 17, portions of this Nitride layer 119 are etched to remove the unwanted nitride and drill release holes 121 though the armature.

The final step is etching off the sacrificial layer using an etching solution, such as Hydrogen Fluoride (HF). The cantilever beam is then released in a supercritical point dryer. The result is the MEMS switch as shown in FIGS. 3A-3E. One skilled in the art will appreciate that the same steps can be used in the manufacture of the MEMS T-switch as shown in FIG. 4.

In one embodiment, the chip size containing the MEMS switch, such as that shown in FIG. 4, is 700×400 microns. The metal electrode pad is on the order of 100×100 microns. The actuation pad may vary from 100-200×100-200 microns depending upon the design of the specific actuation voltage. The RF line may vary between 60-100 microns wide. The above dimensions are provided as exemplary and are not meant to be construed as limiting. Instead, one skilled in the art will appreciate that different dimensions may be used depending upon the size of the MEMS switch being designed and the application for which it is being used.

1. A micro-electro-mechanical system (MEMS) switch comprising:
an actuating portion attached with a substrate;
an actuating portion contact disposed on the actuating portion, the actuating portion contact being located between the actuating portion and the substrate; and
a substrate contact on top of the substrate, the substrate contact including a metal platform portion extending a height therefrom toward the actuating portion contact, wherein the actuating portion contact and the substrate contact are aligned to contact when the actuating portion is moved from a first position to a second position,
wherein an area of the metal platform portion is independently selectable of an area of the actuating portion contact.

2. A switch of claim 1, wherein the metal platform portion is comprised of at least one metal selected from a group consisting of: gold, platinum, silver, copper, aluminum, and molybdenum.

3. A switch of claim 2, wherein the substrate is comprised of at least one material selected from a group consisting of: gallium arsenide, indium phosphide, high resistivity silicon, glass, ceramic, and silicon germanium.

4. A switch of claim 3, wherein the actuating portion is a cantilever structure, the cantilever structure having a first region and a second region, the first region of the cantilever structure being attached with the substrate,

5. A switch of claim 4, further comprising a first RF transmission line and a second RF transmission line formed on the substrate, wherein the actuating portion contact is formed as a contact transmission line having a first contact region and a second contact region, with the first contact region aligned with the at least a portion of the first RF transmission line, and the second contact region aligned with at least a portion of the second RF transmission line, whereby when the cantilever is moved from the first position to the second position, the contact transmission line forms an electrical path between the first and second RF transmission lines.

6. A switch of claim 5 further comprising:
a substrate bias electrode disposed on the substrate; and
a cantilever bias electrode included with the cantilever, the substrate bias electrode and the cantilever bias electrode forming a bias electrode pair such that the bias electrode pair may be actuated to urge the cantilever bias electrode toward substrate bias electrode moving the cantilever structure from the first position to the second position.

7. A switch of claim 4 further comprising a first RF transmission line and a second RF transmission line formed on the substrate, wherein the actuating portion contact is formed as a contact transmission line having a first contact region and a second contact region, with the first contact region attached with at least a portion of the first RF transmission line, and the second contact region aligned with at least a portion of the second RF transmission line, whereby when the cantilever is moved from the first position to the second position, the contact transmission line forms an electrical path between the first and second RF transmission lines.

8. A switch of claim 4, wherein the cantilever structure has into two sections a DC cantilever section and a RF cantilever section, the DC cantilever section being attached with the substrate at a first portion and the RF cantilever section being attached with the substrate at a first portion, the switch further comprising:
a first RF transmission line disposed on the substrate, the first RF transmission line including the substrate contact; and
a second RF transmission line, the second RF transmission line being included with the RF cantilever section, the second RF transmission line including the actuating portion contact,
whereby when the cantilever is moved from the first position to the second position the actuating portion contact contacts the substrate contact creating an electrical path between the first and second RF transmission lines.

9. A switch of claim 8 further comprising:
a substrate bias electrode disposed on the substrate; and
a DC cantilever bias electrode included with the DC cantilever section, the substrate bias electrode and the DC cantilever bias electrode forming a bias electrode pair such that the bias electrode pair may be actuated to urge the DC cantilever bias electrode toward the substrate bias electrode moving the cantilever structure from the first position to the second position.

10. A switch of claim 4, wherein the second region of the cantilever structure is attached with the substrate.

11. A switch of claim 10 further comprising:
a first RF transmission line included with the cantilever structure, wherein the first RF transmission line includes the actuating portion contact;
a second RF transmission line disposed on the substrate, the second RF transmission line including the substrate contact, whereby when the cantilever is moved from the first position to the second position the actuating portion contact contacts the substrate contact.

12. A switch of claim 11 further comprising:
a substrate bias electrode disposed on the substrate; and
a cantilever bias electrode included with the cantilever structure, the substrate bias electrode and the cantilever bias electrode forming a bias electrode pair such that the bias electrode pair may be actuated to urge the cantilever bias electrode toward the substrate bias electrode moving the cantilever structure from the first position to the second position.

13. A switch of claim 1, wherein the substrate is comprised of at least one material selected from a group consisting of: gallium arsenide, indium phosphide, high resistivity silicon, glass, ceramic, and silicon germanium.

14. A switch of claim 1, wherein the actuating portion is a cantilever structure, the cantilever structure having a first region and a second region, the first region of the cantilever structure being attached with the substrate.

15. A switch of claim 1 further comprising:
a substrate bias electrode disposed on the substrate; and
an actuator bias electrode included with the actuating portion, the substrate bias electrode and the actuator bias electrode forming a bias electrode pair such that the bias electrode pair may be actuated to urge the actuator bias electrode toward substrate bias electrode moving the actuating portion from the first position to the second position.

16. A micro-electro-mechanical system (MEMS) switch comprising:
a means for supporting;
a movable portion having a first part and a second part, one part of the movable portion fixed with the means for supporting,
a first means for conducting energy located on the movable portion between the movable portion and the means for supporting; and
a second means for conducting energy located on the means for supporting, wherein the second means for conducting includes a metal platform portion extending a height therefrom in a direction toward the movable portion, wherein the first means for conducting and the metal platform portion are aligned to contact when the movable portion is moved from a first position to a second position,
wherein a top area of the metal platform portion is independently selectable from a top area of the first means for conducting.

17. A switch of claim 16, wherein the metal platform portion is comprised of at least one metal selected from a group consisting of: gold, platinum, silver, copper, aluminum, and molybdenum.

18. A switch of claim 17, wherein the means for supporting is comprised of at least one material selected from a group consisting of: gallium arsenide, indium phosphide, high resistivity silicon, glass, ceramic, and silicon germanium.

19. A switch of claim 18, wherein the movable portion is a cantilever structure, the cantilever structure having a first region and a second region, the first region of the cantilever structure being attached with the means for supporting.

20. A switch of claim 19 further comprising:
a first means for RF transmission and a second means for RF transmission formed on the means for supporting, wherein first means for conducting is formed as third means for RF transmission having a first means for contact and a second means for contact, with the first means for contact aligned with the at least a portion of the first means for RF transmission, and the second means for contact aligned with at least a portion of the second means for RF transmission, whereby when the movable portion is moved form the first position to the second position, the third means for RF transmission forms an electrical path between the first and second means for RF transmission.

21. A switch of claim 20 further comprising:
a first means for moving the movable portion; and
a second means for moving the movable portion, the first means for moving being attached with the means for supporting and the second means for moving being integrated with the movable portion, such that the first and second means for moving may be actuated to urge the first means for moving toward the second means for moving resulting in moving the movable portion from the first position to the second position.

22. A switch of claim 19 further comprising a first means for RF transmission and a second means for RF transmission formed on the means for supporting, wherein first means for conducting is formed as third means for RF transmission having a first means for contact and a second means for contact, with the first means for contact attached with at least a portion of the first means for RF transmission, and the second means for contact aligned with at least a portion of the second means for RF transmission, whereby when the movable portion is moved form the first position to the second position, the third means for RF transmission forms an electrical path between the first and second means for RF transmission.

23. A switch of claim 19, wherein the cantilever structure is divided into two sections a DC cantilever section and a RF cantilever section, the DC cantilever section having a first portion and a second portion, the RF cantilever section having a first portion and a second portion, the first portion of the DC cantilever section being attached with the means for supporting and the first portion of the RF cantilever structure being attached with the means for supporting, the switch further comprising:
a first means for RF transmission disposed on the means for supporting, the first means for transmission including the second means for conducting; and
a second means for RF transmission, the second means for RF transmission being included with the RF cantilever structure,
whereby when the cantilever is moved form the first position to the second position the first means for conducting contacts the second means for conducting creating an electrical path between the first and second means for RF transmission.

24. A switch of claim 23 further comprising: a means for moving the cantilever structure from a first position to a second position.

25. A switch of claim 19, wherein the second region of the cantilever structure is attached with the means for supporting.

26. A switch of claim 25 further comprising:
a first means for RF transmission included with the cantilever structure, wherein the first means for RF transmission includes the first means for conducting;
a second means for RF transmission disposed on the means for supporting, wherein the second means for RF transmission includes the second means for conducting, whereby when the cantilever structure is moved from the first position to the second position the first means for conducting contacts the second means for conducting.

27. A switch of claim 26 further comprising: a means for moving the cantilever structure from the first position to the second position.

28. A switch of claim 27, wherein the means for supporting is comprised of at least one material from a group consisting of: gallium arsenide, indium phosphide, high resistivity silicon, glass, ceramic, and silicon germanium.

29. A switch of claim 16, wherein the movable portion is a cantilever structure, the cantilever structure having a first region and a second region, the first region of the cantilever structure being attached with the means for supporting.

30. A switch of claim 29 further comprising: a means for moving the movable portion from the first position to the second position.

31. A process for manufacturing a micro-electro-mechanical switch, said process comprising the acts of:
forming a base contact electrode having a metal platform portion on a substrate, wherein the metal platform portion protrudes from the substrate;
connecting a movable actuator to said substrate at a first end and extending a second end of said movable actuator above the metal platform portion; and
including an actuator contact with the movable actuator above the metal platform portion, wherein a top area of the metal platform portion is independently selectable from a top area of the actuator contact and wherein the metal platform electrode and the actuator contact are aligned to contact when the movable actuator is moved from a first position to a second position.

32. A process of claim 31, wherein the act of forming a contact electrode having a metal platform portion is performed by acts selected from a group of acts consisting of:
Group 1: depositing a first metal layer on the substrate where the first metal layer forms the contact electrode and the metal platform portion, and depositing a sacrificial layer over at least a portion of the first metal layer; and
Group 2: depositing a first metal layer on the substrate, where the first metal layer forms the contact electrode and depositing a second metal layer on the first metal layer, where the second metal layer forms the metal platform portion, and depositing a sacrificial layer over at least a portion of the first and second metal layers.

33. A process of claim 32, wherein the sacrificial layer is a non-metal layer.

34. A process of claim 33, wherein the wherein the metal platform portion is comprised of at least one metal selected from a group consisting of: gold, platinum, silver, copper, aluminum, and molybdenum.

35. A process of claim 34, wherein the substrate is comprised of at least one material selected from a group consisting of: gallium arsenide, indium phosphide, high resistivity silicon, glass, ceramic, and silicon germanium.

36. A process of claim 31, wherein the wherein the metal platform is comprised of at least one metal selected from a group consisting of: gold, platinum, silver, copper, aluminum, and molybdenum.

37. A MEMS switch produced by the process of claim 31.
